(19) United States
(12) Patent Application Publication
(10) Pub. No.: US 2011/0149021 A1
(43) Pub. Date: Jun. 23, 2011

(54) METHOD AND SYSTEM FOR SHARPNESS PROCESSING FOR 3D VIDEO

(76) Inventors: Samir Hulyalkar, Newtown, PA (US); Ilya Klebanov, Thornhill (CA); Xuemin Chen, Rancho Santa Fe, CA (US); Marcus Kellerman, San Diego, CA (US)

(21) Appl. No.: 12/698,569

(22) Filed: Feb. 2, 2010

Related U.S. Application Data
(60) Provisional application No. 61/287,634, filed on Dec. 17, 2009.

(51) Int. Cl. H04N 13/00; H04N 5/21

(52) U.S. Cl. 348/42; 348/E13.001; 348/625; 348/E05.077

(57) ABSTRACT

A video processing device may enhance sharpness of one or more of a plurality of view sequences extracted from a three dimensional (3D) input video stream. The plurality of extracted view sequences may comprise stereoscopic left and right view sequences of reference fields or frames. The sharpness enhancement processing may be performed based on sharpness related video information, which may be derived from other sequences in the plurality of view sequences, user input, embedded control data, and/or preconfigured parameters. The sharpness related video information may enable classifying images in the 3D input video streams into different regions, and may comprise depth related data and/or point-of-focus related data. Sharpness enhancement processing may be performed variably on background and foreground regions, and/or on in-focus or out-of-focus regions. A 3D output video stream for display may be generated from the plurality of view sequences based on the sharpness processing.

### CROSS-REFERENCE TO RELATED APPLICATIONS/INCORPORATION BY REFERENCE

This patent application makes reference to, claims priority to and claims benefit from U.S. Provisional Application Ser. No. 61/287,634 (Attorney Docket Number 20678US01) which was filed on Dec. 17, 2009.

This application also makes reference to:
U.S. Provisional Application Ser. No. 61/287,624 (Attorney Docket Number 20677US01) which was filed on Dec. 17, 2009;
U.S. application Ser. No. 12/554,416 (Attorney Docket Number 20679US01) which was filed on Sep. 4, 2009;
U.S. application Ser. No. 12/546,644 (Attorney Docket Number 20680US01) which was filed on Aug. 24, 2009;
U.S. application Ser. No. 12/619,461 (Attorney Docket Number 20681US01) which was filed on Nov. 6, 2009;
U.S. application Ser. No. 12/578,048 (Attorney Docket Number 20682US01) which was filed on Oct. 13, 2009;
U.S. Provisional Application Ser. No. 61/287,653 (Attorney Docket Number 20683US01) which was filed on Dec. 17, 2009;
U.S. application Ser. No. 12/604,980 (Attorney Docket Number 20684US02) which was filed on Oct. 23, 2009;
U.S. application Ser. No. 12/545,679 (Attorney Docket Number 20686US01) which was filed on Aug. 21, 2009;
U.S. application Ser. No. 12/560,554 (Attorney Docket Number 20687US01) which was filed on Sep. 16, 2009;
U.S. application Ser. No. 12/560,578 (Attorney Docket Number 20688US01) which was filed on Sep. 16, 2009;
U.S. application Ser. No. 12/560,592 (Attorney Docket Number 20689US01) which was filed on Sep. 16, 2009;
U.S. application Ser. No. 12/604,936 (Attorney Docket Number 20690US01) which was filed on Oct. 23, 2009;
U.S. Provisional Application Ser. No. 61/287,668 (Attorney Docket Number 20691US01) which was filed on Dec. 17, 2009;
U.S. application Ser. No. 12/573,746 (Attorney Docket Number 20692US01) which was filed on Oct. 5, 2009;
U.S. application Ser. No. 12/573,771 (Attorney Docket Number 20693US01) which was filed on Oct. 5, 2009;
U.S. Provisional Application Ser. No. 61/287,673 (Attorney Docket Number 20694US01) which was filed on Dec. 17, 2009;
U.S. Provisional Application Ser. No. 61/287,682 (Attorney Docket Number 20695US01) which was filed on Dec. 17, 2009;
U.S. application Ser. No. 12/605,039 (Attorney Docket Number 20696US01) which was filed on Oct. 23, 2009;
U.S. Provisional Application Ser. No. 61/287,689 (Attorney Docket Number 20697US01) which was filed on Dec. 17, 2009; and
U.S. Provisional Application Ser. No. 61/287,692 (Attorney Docket Number 20698US01) which was filed on Dec. 17, 2009.

Each of the above stated applications is hereby incorporated herein by reference in its entirety

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for sharpness processing for 3D video.

### BACKGROUND OF THE INVENTION

Display devices, such as television sets (TVs), may be utilized to output or playback audiovisual or multimedia streams, which may comprise TV broadcasts, telecasts and/or localized AudioNideo (NV) feeds from one or more available consumer devices, such as videocassette recorders (VCRs) and/or Digital Video Disc (DVD) players. TV broadcasts and/or audiovisual or multimedia feeds may be inputted directly into the TVs, or it may be passed intermediately via one or more specialized set-top boxes that may enable providing any necessary processing operations. Exemplary types of connectors that may be used to input data into TVs include, but not limited to, F-connectors, S-video, composite and/or video component connectors, and/or, more recently, High-Definition Multimedia Interface (HDMI) connectors.

Television broadcasts are generally transmitted by television head-ends over broadcast channels, via RF carriers or wired connections. TV head-ends may comprise terrestrial TV head-ends, Cable-Television (CATV), satellite TV head-ends and/or broadband television head-ends. Terrestrial TV head-ends may utilize, for example, a set of terrestrial broadcast channels, which in the U.S. may comprise, for example, channels 2 through 69. Cable-Television (CATV) broadcasts may utilize even greater number of broadcast channels. TV broadcasts comprise transmission of video and/or audio information, wherein the video and/or audio information may be encoded into the broadcast channels via one of plurality of available modulation schemes. TV Broadcasts may utilize analog and/or digital modulation format. In analog television systems, picture and sound information are encoded into, and transmitted via analog signals, wherein the video/audio information may be conveyed via broadcast signals, via amplitude and/or frequency modulation on the television signal, based on analog television encoding standard. Analog television broadcasters may, for example, encode their signals using NTSC, PAL and/or SECAM analog encoding and then modulate these signals onto a VHF or UHF RF carriers, for example.

In digital television (DTV) systems, television broadcasts may be communicated by terrestrial, cable and/or satellite head-ends via discrete (digital) signals, utilizing one of available digital modulation schemes, which may comprise, for example, QAM, VSB, QPSK and/or OFDM. Because the use of digital signals generally requires less bandwidth than analog signals to convey the same information, DTV systems may enable broadcasters to provide more digital channels within the same space otherwise available to analog television systems. In addition, use of digital television signals may enable broadcasters to provide high-definition television (HDTV) broadcasting and/or to provide other non-television related service via the digital system. Available digital television systems comprise, for example, ATSC, DVB, DMB-T/H and/or ISDN based systems. Video and/or audio information may be encoded into digital television signals utilizing various video and/or audio encoding and/or compression algorithms, which may comprise, for example, MPEG-1/2, MPEG-4 AVC, MP3, AC-3, AAC and/or HE-AAC.

Nowadays most TV broadcasts (and similar multimedia feeds), utilize video formatting standard that enable communication of video images in the form of bit streams. These video standards may utilize various interpolation and/or rate conversion functions to present content comprising still and/or moving images on display devices. For example, de-interlacing functions may be utilized to convert moving and/or still images to a format that is suitable for certain types of display devices that are unable to handle interlaced content. TV broadcasts, and similar video feeds, may be interlaced or progressive. Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field. In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for sharpness processing for 3D video, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video system that may support video playback based on TV broadcasts and/or local multimedia feeds, in accordance with an embodiment of the invention.

FIG. 2A is a block diagram illustrating an exemplary video system that may be operable to provide communication of 3D video content, in accordance with an embodiment of the invention.

FIG. 2B is a block diagram illustrating an exemplary video processing system that may be operable to generate video streams comprising 3D video content, in accordance with an embodiment of the invention.

FIG. 2C is a block diagram illustrating an exemplary video processing system that may be operable to process input video streams comprising 3D video content to facilitate 3D playback, in accordance with an embodiment of the invention.

FIG. 3 is a flow chart that illustrates exemplary steps for performing sharpness enhancement on 3D video content during 3D playback operations, in accordance with an embodiment of the invention.

### DETAILED DESCRIPTION OF THE INVENTION

Certain embodiments of the invention may be found in a method and system for sharpness processing for 3D video. In various embodiments of the invention, a video processing device may be utilized to extract a plurality of view sequences from a compressed three-dimension (3D) input video stream, and may enhance sharpness of one or more of the plurality of extracted view sequences based on, for example, sharpness related information. The plurality of extracted view sequences may comprise stereoscopic left view and right view sequences of reference fields or frames. The sharpness related information may enable classifying images in the 3D input video stream into different regions, to enable variably applying sharpness enhancement with the extracted view sequences. The sharpness related information may be derived from video data corresponding to the view sequences, user input, control data embedded into the received 3D input stream, and/or preconfigured and/or predetermined sharpness parameters. The sharpness related information derived from the video data corresponding to the view sequences may comprise, for example, depth related data and/or point-of-focus related data. Accordingly, sharpness enhancement processing may be performed variably on background and foreground regions, and/or on in-focus or out-of-focus regions. In this regard, sharpness in foreground regions and/or in-focus regions may be enhanced more than background regions and/or out-of-focus regions. A 3D output video stream for playback via display device may be generated from the plurality of view sequences based on the sharpness processing. The generated 3D output video stream may be processed to ensure that it may be suitable for playback via the display device, by performing, for example, motion compensation and/or frame upconversion, which may be performed utilizing frame interpolation, for example.

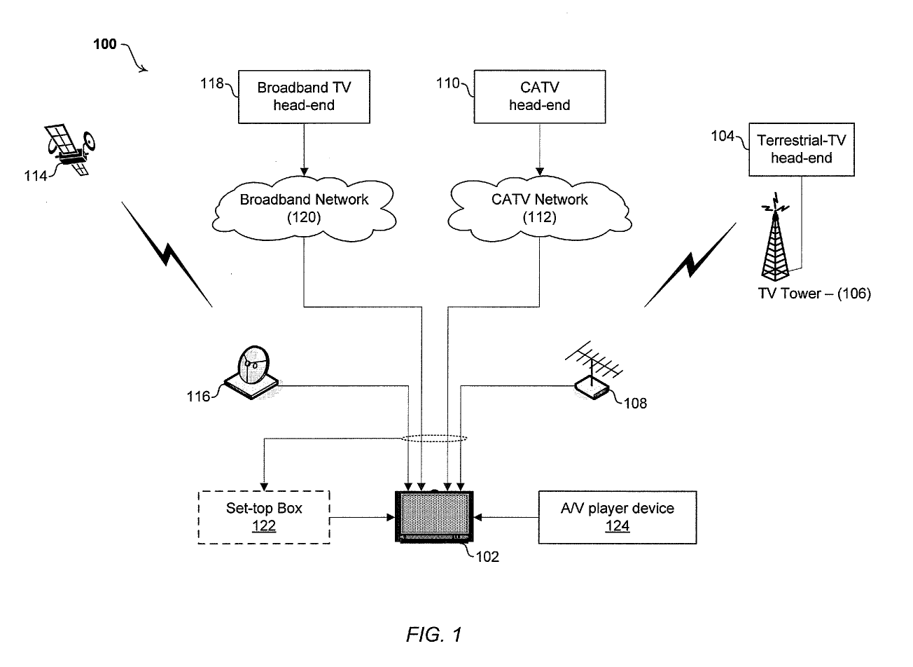

FIG. 1 is a block diagram illustrating an exemplary video system that may support video playback based on TV broadcasts and/or local multimedia feeds, in accordance with an embodiment of the invention. Referring to FIG. 1, there is shown a media system 100, which may comprise a display device 102, a terrestrial-TV head-end 104, a TV tower 106, a TV antenna 108, a cable-TV (CATV) head-end 110, a cable-TV (CATV) distribution network 112, a satellite-TV head-end 114, a satellite-TV receiver 116, a broadband-TV head-end 118, a broadband network 120, a set-top box 122, and an audio-visual (AV) player device 124.

The display device 102 may comprise suitable logic, circuitry, interfaces and/or code that enable playing of multimedia streams, which may comprise audio-visual (AV) content. The display device 102 may comprise, for example, a television, a monitor, and/or other display/audio playback devices, and/or components that may be operable to playback video streams and/or corresponding audio data. The content played via the display 102 may be broadcasted and received directly by the display device 102 and/or indirectly via intermediate devices, such as the set-top box 122, and/or may be provided from local media recording/playing devices and/or storage resources, such as the AV player device 124.

The terrestrial-TV head-end 104 may comprise suitable logic, circuitry, interfaces and/or code that may enable over-the-air broadcast of TV signals, via one or more of the TV tower 106. The terrestrial-TV head-end 104 may be enabled to broadcast digital and/or analog encoded terrestrial TV signals. The TV antenna 108 may comprise suitable logic, circuitry, interfaces and/or code that may enable reception of TV signals transmitted by the terrestrial-TV head-end 104, via the TV tower 106. The CATV head-end 110 may comprise suitable logic, circuitry, interfaces and/or code that may enable communication of cable-TV signals. The CATV head-end 110 may be enabled to broadcast analog and/or digital formatted cable-TV signals. The CATV distribution network 112 may comprise suitable distribution systems that may enable forwarding of communication from the CATV head-end 110 to a plurality of cable-TV recipients, comprising, for example, the display device 102. For example, the CATV distribution network 112 may comprise a network of fiber optics and/or coaxial cables providing connectivity between one or more instances of the CATV head-end 110 and the display device 102.

The satellite-TV head-end 114 may comprise suitable logic, circuitry, interfaces and/or code that may enable down link communication of satellite-TV signals to terrestrial recipients, such as the display device 102. The satellite-TV head-end 114 may comprise, for example, one of a plurality of orbiting satellite nodes in a satellite-TV system. The satellite-TV receiver 116 may comprise suitable logic, circuitry, interfaces and/or code that may enable reception of downlink satellite-TV signals transmitted by the satellite-TV head-end 114. For example, the satellite receiver 116 may comprise a dedicated parabolic antenna operable to receive satellite signals communicated from satellite television head-ends, and to reflect and/or concentrate the received satellite signal into focal point wherein one or more low-noise-amplifiers (LNAs) may be utilized to down-convert the received signals to corresponding intermediate frequencies that may be further processed to enable extraction of AV content. Because most satellite-TV downlink feeds may be securely encoded and/or scrambled, the satellite-TV receiver 116 may also comprise suitable logic, circuitry, interfaces and/or code that may enable decoding, descrambling, and/or deciphering of received satellite-TV feeds.

The broadband-TV head-end 118 may comprise suitable logic, circuitry, interfaces and/or code that may enable multimedia/TV broadcasts via the broadband network 120. The broadband network 120 may comprise a system of interconnected networks that may enable exchange of data and/or information among a plurality of nodes, based on one or more networking standards, such as TCP/IP. The broadband network 120 may comprise a plurality of broadband capable sub-networks, which may include, for example, satellite networks, cable networks, DVB networks, the Internet, and/or other local or wide area networks, which collectively may enable conveying data comprising multimedia content to plurality of end users. The broadband-TV head-end 118 and the broadband network 120 may correspond to, for example, an Internet Protocol Television (IPTV) system.

The set-top box 122 may comprise suitable logic, circuitry, interfaces and/or code that may enable processing of TV and/or multimedia streams/signals, received from TV head-ends, external to the display device 102. The AV player device 124 may comprise suitable logic, circuitry, interfaces and/or code that may provide local AV feeds for playback via the display device 102. The AV player device 124 may comprise a digital video disc (DVD) player, a Blu-ray player, a digital video recorder (DVR), a video personal computer (PC) capture/playback card, a surveillance system, and/or a game console. While the set-top box 122 and the AV player device 124 are shown as separate entities, at least some of the functions performed via the top box 122 and/or the AV player device 124 may be integrated directly into the display device 102.

In operation, the display device 102 may be utilized to playback media streams received from one of available broadcast head-ends, and/or from one or more local sources. The display device 102 may receive, for example, via the TV antenna 108, over-the-air TV broadcasts from the terrestrial-TV head end 104 transmitted via the TV tower 106. The display device 102 may also receive cable-TV broadcasts, which may be communicated by the CATV head-end 110 via the CATV distribution network 112; satellite TV broadcasts, which may be communicated by the satellite head-end 114 and received via the satellite receiver 116; and/or Internet media broadcasts, which may be communicated by the broadband-TV head-end 118 via the broadband network 120. In this regard, the TV head-ends may utilize various formatting schemes in TV broadcasts. Historically, TV broadcasts have utilized analog modulation format schemes, comprising, for example, NTSC, PAL, and/or SECAM. Audio encoding may comprise utilization of separate modulation scheme, comprising, for example, BTSC, NICAM, mono FM, and/or AM. More recently, however, there has been a steady move towards Digital TV (OW) based broadcasting. For example, the terrestrial-TV head-end 104 may be enabled to utilize ATSC and/or DVB based standards to facilitate DTV terrestrial broadcasts. Similarly, the CATV head-end 110 and/or the satellite head-end 114 may also be enabled to utilize appropriate encoding standards to facilitate cable and/or satellite based broadcasts. The display device 102 may directly process multimedia/TV broadcasts to enable playing of corresponding video and/or audio data. Alternatively, an external device, such as the set-top box 122, may be used to perform at last some of the processing external to the display device 102, and may, for example, extract and/or generate AV content from received media streams and then transfer to the display device 102 for playback.

In exemplary aspect of the invention, the media system 100 may be operable to support three-dimensional (3D) video. In various video related applications such as, for example, DVD/Blu-ray movies and/or digital TV, use of 3D video may be more desirable because 3D perception it is more realistic to humans. Various techniques may be utilized to capture, generate (at capture and/or playtime), and/or render 3D video images. One of the more common techniques for implementing 3D video is stereoscopic 3D video. In stereoscopic 3D video based applications the 3D video impression is generated by rendering multiple views, most commonly two views: a left view and a right view, corresponding to the viewer's left eye and right eye, to give depth to displayed images. In this regard, the left view and the right view sequences may be captured and/or processed to enable creating 3D images. The video data corresponding to the left view and right view sequences may then be communicated either as separate streams, or may be combined into a single transport stream and only separated into different view sequences by the end-user receiving/displaying device. The stereoscopic 3D video may communicated via TV broadcasts. In this regard, one or more of the TV head-ends may be operable to communicate 3D video content to the display device 102, directly and/or via the set-top box 122. The communication of stereoscopic 3D video may also be performed by use of multimedia storage devices, such as DVD or Blu-ray discs, which may be used to store 3D video data that subsequently may be played back via an appropriate player, such as the AV player device 124. Various compression/encoding standards may be utilized to enable compressing and/or encoding of the view sequences into transport streams during communication of stereoscopic 3D video. For example, the separate left and right view sequences may be compressed based on MPEG-2 MVP, H.264 and/or MPEG-4 advanced video coding (AVC) or MPEG-4 multi-view video coding (MVC).

In various embodiments of the invention, sharpness processing may be performed on 3D video content during playback operations. In this regard, the 3D video content may be received and/or extracted, by the display device 102 independently and/or in conjunction with the set-top box 122, from TV broadcasts and/or local AV feeds provided by, for example, player devices such as the AV player device 124. The 3D video content may comprise, for example, a plurality of stereoscopic 3D views, most commonly left and right views. Once received, the 3D video content may be processed to extract the left view and right view sequences of frames or fields, and corresponding output streams comprising 3D video frames or fields may then be generated for display. Data corresponding to the output 3D video frames or fields may be generated by combining, for example, data from the left view and right view sequences.

During processing of the extracted view sequences (e.g. the left and right views), each view sequence may be dynamically processed to enhance the sharpness of corresponding output images, and/or regions therein, corresponding to that view sequence. In this regard, sharpness may refer to and/or describe the clarity of detail in images. Various factors and/or parameters may be utilized to control and/or adjust such sharpness enhancement processing. For example, during sharpness enhancement processing, 3D video related data and/or information may be extracted and/or generated, and may be utilized to control and/or adjust the sharpness enhancement processing. In instances where the 3D video content comprises stereoscopic left and right view sequences, for example, the sharpness related video data may be generated based on video data corresponding to the view sequences, and may comprise depth related data. In this regard, the depth related data may enable determining foreground and/or background regions in the images corresponding to the view sequences. Accordingly, to ensure satisfactory image quality, the sharpness enhancement processing may be performed variably for the different depth related regions. For example, the foreground regions may be subjected to higher degrees of sharpness enhancement.

The sharpness related video data may also comprise point-of-focus data, which may be utilized to determine in-focus and/or out-of-focus regions in the images corresponding to the view sequences. In this regard, the in-focus region may comprise regions of the image where the focus of viewers is directed, for example faces. Accordingly, the sharpness enhancement processing may similarly be performed variably for the different point-of-focus related regions. For example, the in-focus regions may be subjected to higher degrees of sharpness enhancement. The sharpness enhancement processing may also be controlled and/or adjusted based on user input, predetermined and/or preconfigured parameters, and/or sharpness processing related control information which may be embedded within multimedia streams comprising the 3D content.

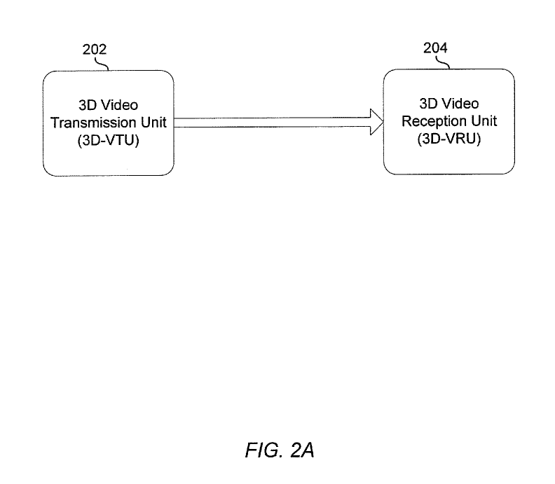

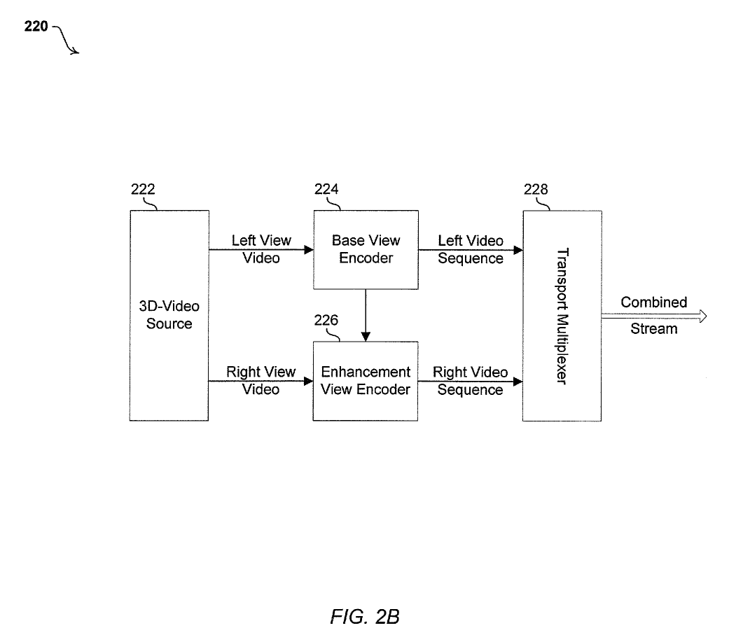

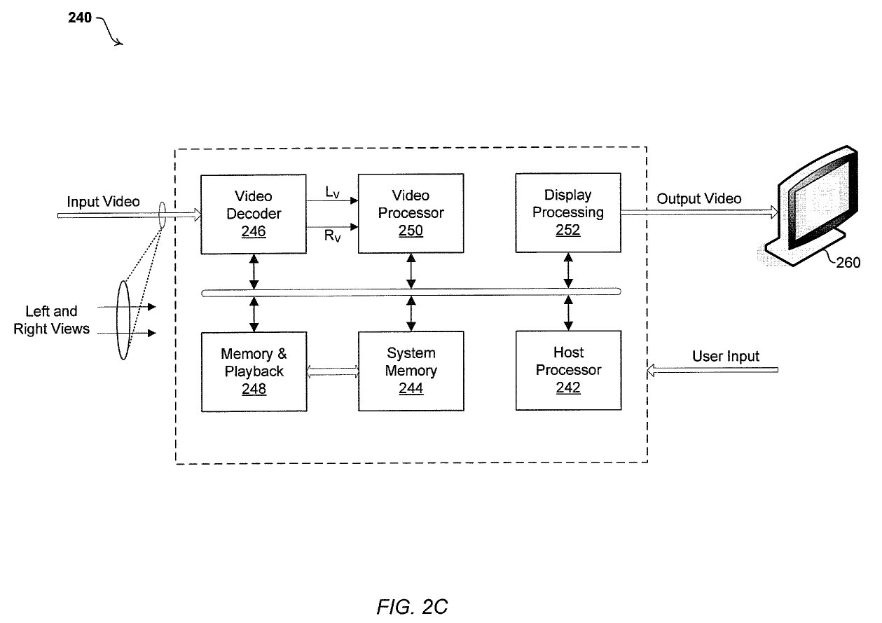

FIG. 2A is a block diagram illustrating an exemplary video system that may be operable to provide communication of 3D video content, in accordance with an embodiment of the invention. Referring to FIG. 2A, there is shown a 3D video transmission unit (3D-VTU) 202 and a 3D video reception unit (3D-VRU) 204.

The 3D-VTU 202 may comprise suitable logic, circuitry, interfaces and/or code that may be operable to generate video streams that may comprise encoded/compressed 3D video data, which may be communicated, for example, to the 3D-VRU 204 for display and/or playback. The 3D video generated via the 3D-VTU 202 may be communicated via TV broadcasts, by one or more TV head-ends such as, for example, the terrestrial-TV head-end 104, the CATV head-end 110, the satellite head-end 114, and/or the broadband-TV head-end 118 of FIG. 1. The 3D video generated via the 3D-VTU 202 may be stored into multimedia storage devices, such as DVD or Blu-ray discs.

The 3D-VRU 204 may comprise suitable logic, circuitry, interfaces and/or code that may be operable to receive and process video streams comprising 3D video data for display and/or playback. The 3D-VRU 204 may be operable to, for example, receive and/or process transport streams comprising 3D video data, which may be communicated directly by, for example, the 3D-VTU 202 via TV broadcasts. The 3D-VRU 204 may also be operable receive video streams generated via the 3D-VTU 202, which are communicated indirectly via multimedia storage devices that may be played directly via the 3D-VRU 204 and/or via local suitable player devices. In this regard, the operations of the 3D-VRU 204 may be performed, for example, via the display device 102, the set-top box 122, and/or the AV player device 124 of FIG. 1. The received video streams may comprise encoded/compressed 3D video data. Accordingly, the 3D-VRU 204 may be operable to process the received video stream to separate and/or extract various video contents in the transport stream, and may be operable to decode and/or process the extracted video streams and/or contents to facilitate display operations. In an exemplary aspect of the invention, the 3D-VRU 204 may be operable to perform sharpness processing and/or enhancement on received 3D video content, which may be performed dynamically on view sequence to enhance the sharpness of corresponding output images, and/or regions therein, corresponding to that view sequence.

In operation, the 3D-VTU 202 may be operable to generate video streams comprising 3D video data. The 3D-VTU 202 may encode, for example, the 3D video data as stereoscopic 3D video comprising left view and right view sequences. The 3D-VRU 204 may be operable to receive and process the video streams to facilitate playback of video content included in the video stream via appropriate display devices. In this regard, the 3D-VRU 204 may be operable to, for example, demultiplex received transport stream into encoded 3D video streams and/or additional video streams. The 3D-VRU 204 may be operable to decode the encoded 3D video data for display.

In an exemplary aspect of the invention, the 3D-VRU 204 may be operable to perform sharpness enhancement processing operations during reception and/or processing of video streams communicated by the 3D-VTU 202, substantially as described with regard to, for example, FIG. 1. In this regard, in instances where the 3D video content received via the 3D-VRU 204 may comprise a plurality of stereoscopic 3D views, 3D-VRU 204 may be operable to dynamically process each view sequence to enhance the sharpness of corresponding output frames or fields, and/or regions therein, during playback of the received 3D video content. In this regard, the sharpness enhancement processing may be performed based on, and/or be controlled by various factors and/or parameters. For example, the sharpness enhancement process may be performed based on, for example, 3D video related data and/or information that may be extracted and/or generated during processing of the 3D content. The sharpness enhancement process may also be performed based on user input, predetermined and/or preconfigured parameters, and/or sharpness processing related control information, which may be embedded within multimedia streams comprising the 3D content.

FIG. 2B is a block diagram illustrating an exemplary video processing system that may be operable to generate video streams comprising 3D video content, in accordance with an embodiment of the invention. Referring to FIG. 2B, there is shown a video processing system 220, a 3D-video source 222, a base view encoder 224, an enhancement view encoder 226, and a transport multiplexer 228.

The video processing system 220 may comprise suitable logic, circuitry, interfaces and/or code that may be operable to capture, generate, and/or process 3D video data, and to generate transport streams comprising the 3D video. The video processing system 220 may comprise, for example, the 3D-video source 222, the base view encoder 224, the enhancement view encoder 226, and/or the transport multiplexer 228. The video processing system 220 may be integrated into the 3D-VTU 202 to facilitate generation of video and/or transport streams comprising 3D video data.

The 3D-video source 222 may comprise suitable logic, circuitry, interfaces and/or code that may be operable to capture and/or generate source 3D video contents. The 3D-video source 222 may be operable to generate stereoscopic 3D video comprising video data for left view and right views from the captured source 3D video contents, to facilitate 3D video display/playback. The left view video and the right view video may be communicated to the base view encoder 224 and the enhancement view encoder 226, respectively, for video compressing.

The base view encoder 224 may comprise suitable logic, circuitry, interfaces and/or code that may be operable to encode the left view video from the 3D-video source 222, for example on frame by frame basis. The base view encoder 224 may be operable to utilize various video encoding and/or compression algorithms such as those specified in MPEG-2, MPEG-4, AVC, VC1, VP6, and/or other video formats to form compressed and/or encoded video contents for the left view video from the 3D-video source 222. In addition, the base view encoder 224 may be operable to communication information, such as the scene information from base view coding, to the enhancement view encoder 226 to be used for enhancement view coding.

The enhancement view encoder 226 may comprise suitable logic, circuitry, interfaces and/or code that may be operable to encode the right view video from the 3D-video source 222, for example on frame by frame basis. The enhancement view encoder 226 may be operable to utilize various video encoding and/or compression algorithms such as those specified in MPEG-2, MPEG-4, AVC, VC1, VP6, and/or other video formats to form compressed or encoded video content for the right view video from the 3D-video source 222. Although a single enhancement view encoder 226 is illustrated in FIG. 2B, the invention may not be so limited. Accordingly, any number of enhancement view video encoders may be used for processing the left view video and the right view video generated by the 3D-video source 222 without departing from the spirit and scope of various embodiments of the invention.

The transport multiplexer 228 may comprise suitable logic, circuitry, interfaces and/or code that may be operable to merge a plurality of video sequences into a single compound video stream. The combined video stream may comprise the left (base) view video sequence, the right (enhancement) view video sequence, and a plurality of addition video streams, which may comprise, for example, advertisement streams.

In operation, the 3D-video source 222 may be operable to capture and/or generate source 3D video contents to produce, for example, stereoscopic 3D video data that may comprise a left view video and a right view video for video compression. The left view video may be encoded via the base view encoder 224 producing the left (base) view video sequence. The right view video may be encoded via the enhancement view encoder 226 to produce the right (enhancement) view video sequence. The base view encoder 224 may be operable to provide information such as the scene information to the enhancement view encoder 226 for enhancement view coding, to enable generating depth data, for example. Transport multiplexer 228 may be operable to combine the left (base) view video sequence and the right (enhancement) view video sequence to generate a combined video stream. Additionally, one or more additional video streams may be multiplexed into the combined video stream via the transport multiplexer 228. The resulting video stream may then be communicated, for example, to the 3D-VRU 204, substantially as described with regard to FIG. 2A.

In an exemplary aspect of the invention, the 3D video content generated and/or captured via the video processing system 220 may be subjected to sharpness enhancement processing playback operations, substantially as described with regard to, for example, FIG. 1. In this regard, after the left and right view sequences are extracted, after reception and/or processing of combined streams generated via the transport multiplexer 228, each of the left and right view sequences may be dynamically processed to enhance the sharpness of corresponding output frames or fields, and/or regions therein, during playback operations. The sharpness enhancement processing may be performed based on, be by controlled, and/or adjusted by various factors and/or parameters. For example, sharpness enhancement processing may be performed based on, for example, 3D video related data and/or information that may be extracted and/or generated during processing of the 3D content. The sharpness enhancement process may performed based on user input, predetermined and/or preconfigured parameters, and/or sharpness processing related control information which may be embedded within combined streams.

FIG. 2C is a block diagram illustrating an exemplary video processing system that may be operable to process input video streams comprising 3D video content to facilitate 3D playback, in accordance with an embodiment of the invention. Referring to FIG. 2C there is shown a video processing system 240, a host processor 242, a system memory 244, an video decoder 246, a memory and playback module 248, a video decoder 248, a video processor 250, a display processing module 252, and a display 260.

The video processing system 240 may comprise suitable logic, circuitry, interfaces and/or code that may be operable to receive and process 3D video data in a compression format, and may render reconstructed output video for display. The video processing system 240 may comprise, for example, the host processor 242, the system memory 244, the video decoder 246, the memory and playback module 248, the video processor 250, the graphics processor 252, the video blender 254, and/or the display processing module 252. The video processing system 240 may be integrated into, for example, the 3D-VRU 204 to facilitate reception and/or processing of transport streams comprising 3D video content communicated by the 3D-VTU 202. The video processing system 240 may be operable to handle interlaced video fields and/or progressive video frames. In this regard, the video processing system 240 may be operable to decompress and/or up-convert interlaced video and/or progressive video. The video fields, for example, interlaced fields and/or progressive video frames may be referred to as fields, video fields, frames or video frames. In an exemplary aspect of the invention, the video processing system 240 may be operable to generate local graphics and/or to incorporate them, as 3D video data, into received 3D video streams.

The host processor 242 may comprise suitable logic, circuitry, interfaces and/or code that may be operable to process data and/or control operations of the video processing system 240. In this regard, the host processor 242 may be operable configure and/or controlling operations of various other components and/or subsystems of the video processing system 240, by providing, for example, control signals. The host processor 242 may also control data transfers within the video processing system 240, during video processing operations for example. The host processor 242 may enable execution of applications, programs and/or code, which may be stored in the system memory 244, to enable, for example, performing various video processing operations such as decompression, motion compensation operations, interpolation or otherwise processing 3D video data. The system memory 244 may comprise suitable logic, circuitry, interfaces and/or code that enable permanent and/or non-permanent storage and/or fetch of data, code and/or other information used in the video processing system 240. In this regard, the system memory 244 may comprise different memory technologies, including, for example, read-only memory (ROM), random access memory (RAM), and/or Flash memory. The system memory 244 may be may operable to store, for example, information comprising parameter(s) and/or code used during video processing operations in the video processing system 240. The parameter(s) may comprise configuration data and the code may comprise operational code such as software and/or firmware, but the information need not be limited in this regard. Additionally, the system memory 244 may be operable to store 3D video content comprising, for example, data corresponding to left and right views of stereoscopic 3D video.

The video decoder 246 may comprise suitable logic, circuitry, interfaces and/or code that may be operable to process encoded/compressed video data, performing, for example, video decompression and/or decoding operations. In instances where the compressed/encoded video data is communicated as transport streams, which may be received as TV broadcasts and/or local AV feeds, the video decoder 246 may be operable to demultiplex and/or parse received transport streams to extract video streams and/or sequences within them, and/or to decompress video data that may be carried via the received transport streams. The video decoder 246 may also perform additional security operations such as digital rights management (DRM). The compressed/encoded video data may comprise, for example, 3D video content corresponding to a plurality of stereoscopic view sequences of frames or fields, such as left and review views. The received video data may be compressed and/or encoded via MPEG-2 transport stream (TS) protocol or MPEG-2 program stream (PS) container formats, for example. In some embodiments of the invention, data corresponding to the stereoscopic left and right views may be received in separate streams or separate files. In this regard, the video decoder 246 may decompress the received separate left and right view video data based on, for example, MPEG-2 MVP, H.264 and/or MPEG-4 advanced video coding (AVC) or MPEG-4 multi-view video coding (MVC). In other embodiments of the invention, data corresponding to the stereoscopic left and right views may be combined into a single sequence. For example, side-by-side, top-bottom and/or checkerboard lattice based 3D encoders may convert frames from a 3D stream comprising left view data and right view data into a single-compressed frame and may use MPEG-2, H.264, AVC and/or other encoding techniques. In this instance, the video data may be decompressed by the video decoder 246 based on MPEG-4 AVC and/or MPEG-2 main profile (MP), for example.

The memory and playback module 248 may comprise suitable logic, circuitry interfaces and/or code that may be operable to buffer video data, which may comprise, for example, data corresponding to stereoscopic left are right views, while it is being transferred from one process and/or component to another, and/or processed therein. In this regard, the memory and playback module 248 may receive decompresses and/or decoded video data from the video decoder 246, and may store, retrieve, transfer and/or buffer the video data during video processing operations. For example, the memory and playback module 248 may store, retrieve, transfer and/or buffer decompressed reference frames and/or fields during frame interpolation via the display processing module 252, and/or during sharpness enhancement processing via the video processor 250. The memory and playback module 248 may also write the video data to the system memory 244 for longer term storage.

The video processor 250 may comprise suitable logic, circuitry, interfaces and/or code that may be operable to perform video processing operations on received video data to facilitate generating corresponding output video streams, which may be displayed via, for example, the display 260. The video processor 250 may be operable, for example, to generate video frames and/or fields that may provide 3D video playback via the display 260 based on a plurality of view sequences extracted from the received streams. In this regard, the video processor 250 may utilize the video data, such as luma and/or chroma data, in the received view sequences of frames and/or fields. The video processor 250 may also be operable to perform graphics processing locally within the video processing system 240 based on, for example, the focal point of view. In this regard, the video processor 250 may be operable to generate graphic objects that may be composited into output video streams generated via the video processing system 240 may be operable to generate graphic objects that may be composited and/or incorporated into the output video stream. In this regard, the local graphics may comprise on-screen display (OSD) graphics, which may provide a user interface that enable video playback, control and/or setup. The graphic objects may be generated based on, for example, the focal point of view.

In an exemplary aspect of the invention, the video processor 250 may be operable to perform sharpness enhancement processing during video processing operations on received 3D video content, substantially as described with regard to, for example, FIG. 1. In this regard, in instances where the 3D video content comprise video data corresponding to a plurality of views, the video processor 250 may dynamically perform sharpness enhancement on one or more of the view sequences.

The display processing module 252 may comprise suitable logic, circuitry, interfaces and/or code that may be operable to process video data generated and/or processed via the video processing system 240 to generate an output video stream that is suitable for playback via the display 260. The display processing module 252 may perform, for example, frame upconversion based on motion estimation and/or motion compensation to increase the number of frames where the display 260 has higher frame rate than the input video streams. In this regard, the display processing module 252 may utilize frame interpolation to generate additional frames and/or fields to increase the frame rate of the generated output streams. In instances where the display 260 is not 3D capable, the display processing module 252 may be operable, to convert 3D video data generated and/or processed via the video processing system 240 to 2D output video.

The display 260 may comprise suitable logic, circuitry, interfaces and/or code that may be operable to receive reconstructed fields and/or frames of video data after processing in the display processing module 252 and may display corresponding images. The display 260 may be a separate device, or the display 260 and the video processing system 240 may implemented as single unitary device. The display 260 may be operable to perform 2D and/or 3D video display. In this regard, a 2D display may be operable to display video that was generated and/or processed utilizing 3D techniques.

In operation, the video processing system 240 may be utilized to facilitate reception and/or processing of input streams, which may comprise 3D video content, to and to generate and process output video streams that are playable via a local display device, such as the display 260. Processing the received transport streams may comprise demultiplexing the transport stream to extract, for example compressed and/or encoded video data corresponding to, for example, stereoscopic 3D view sequences. Demultiplexing transport streams may be performed within the video decoder 246, or via a separate component (not shown). The compressed/encoded video data may correspond to left and right stereoscopic views. The decoder 246 may decompress and/or decode video data corresponding to the left and right views, and may buffer the decompressed video data via the memory and playback module 246. The decompressed video data may then be processed to facilitate playback via the display 260. For example, the video processor 250 may perform various video processing operations on the decompressed video data to facilitate generating output video streams, which may be 3D and/or 2D, based on the decompressed video data. In this regard, in instances where stereoscopic 3D video is utilized, the video processor 250 may process decompressed reference frames and/or fields, corresponding to plurality of view sequences, such as left and right views, which may be retrieved via the memory and playback module 248, to enable generation of corresponding output video steams that may be further processed via the display processing module 252 prior to playback via the display 260. For example, the display transform module 256 may perform, where necessary, motion compensation and/or may interpolate pixel data in one or more frames or fields between the received frames or fields in order to enable the frame rate upconversion. The video processor 250 may also provide local graphics processing, to enable splicing and/or compositing OSD graphics, for example, into the generated video output streams.

In various embodiments of the invention, the video processing system 240 may be operable to perform sharpness processing on 3D video content during playback operations. For example, the video decoder 246 may be operable to receive input stream, and to extract compressed/encoded data corresponding to the 3D video content, and decode and/or decompress the video data. The 3D video content may comprise, for example, a plurality of stereoscopic 3D sequences of video frames or fields corresponding to multiple views, most commonly left and right views. Accordingly, corresponding left and right view sequences of frames or fields may be generated and/or extracted, via the video decoder 246, based on the received 3D video content. The left and right view sequences may then be processed, via the video processor 250 for example, to facilitate generating corresponding output video streams for playback via the display 260. During processing of the left and right view sequences, each view sequence may be dynamically processed, separately, via the video processor 250, to enhance the sharpness of corresponding images, and/or regions therein. The enhanced view sequences may then be utilized to generate corresponding output video stream, which may be played back via the display 260. In instances where local graphics are generated and/or processed, via the video processor 250 for example, the graphics processing may be performed prior to the sharpness enhancement processing, to ensure that the sharpness processing account for regions corresponding to local graphics. Alternatively, local graphics may be generated and/or processed after sharpness enhancement processing is performed on the native video such that the local graphics may simply be overlaid on already enhanced images. Once the output stream is generated, video frames or fields in the output video stream may be post-processed to equalize and/or balance sharpness in the corresponding 3D video frames or fields.

During sharpness enhancement processing, various factors and/or parameters may be utilized to control and/or adjust such sharpness enhancement processing. For example, video processing of 3D video content extracted from received input streams, sharpness related 3D video data and/or information may be extracted and/or generated, via the video decoder 246, the video processor 250 and/or the host processor 242 for example. The sharpness related 3D video data may be buffered, via the memory and playback module 248 for example, and may subsequently be utilized to control and/or adjust the sharpness enhancement processing performed via the video processor 250. In this regard, in instances where the 3D video content comprises stereoscopic left and right view sequences, sharpness related 3D video data may be generated, via the host processor 242 and/or the video processor 250 for example, based on video data corresponding to the left and right view sequences, and may comprise depth related data. In this regard, the depth related data may enable determining foreground and/or background regions in the images corresponding to the left and right view sequences. Accordingly, the video processor 250 may perform sharpness enhancement processing variably for the different depth related regions in each of the left and right views. For example, the foreground regions may be subjected to higher degrees of sharpness enhancement.

The sharpness related 3D video data may also comprise point-of-focus data, which may enable determining in-focus and/or out-of-focus regions in the images corresponding to the view sequences. In this regard, the in-focus region may comprise regions of the image where the focus of viewers is directed, for example, to faces. Accordingly, the video processor 250 may perform sharpness enhancement processing variably in the different point-of-focus related regions. For example, the in-focus regions may be subjected to higher degrees of sharpness enhancement. Other factors and/or parameters may also be utilized to control and/or adjust sharpness processing via the video processing system 240. For example, the sharpness enhancement processing may be controlled and/or adjusted based on user input, which may be received via direct interactions with the video processing system 240 and/or via OSD based interactions via the display 260, which may be effectuated via local graphics processing that may provided via the video processor 250. Predetermined and/or preconfigured parameters may also be utilized to control and/or adjust sharpness enhancement processing. In this regard, the sharpness parameters and/or data may be stored into the system memory 244. Sharpness enhancement processing related control information may also be embedded within input streams received via the video processing system 240, and may be extracted via the video decoder 246, and used during sharpness enhancement processing via the video processor 250.

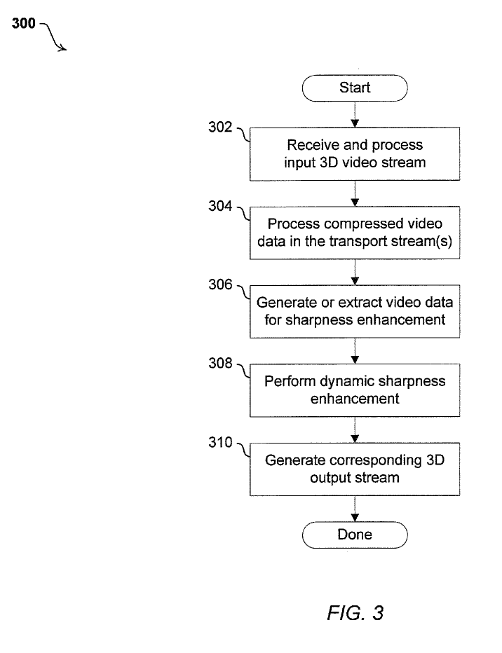

FIG. 3 is a flow chart that illustrates exemplary steps for performing sharpness enhancement on 3D video content during 3D playback operations, in accordance with an embodiment of the invention. Referring to FIG. 3, there is shown a flow chart 300 comprising a plurality of exemplary steps that may be performed to enable sharpness processing for 3D video.

In step 302, transport streams comprising video data may be received and processed. For example, the video processing system 240 may be operable to receive and process input streams comprising compressed video data, which may correspond to stereoscopic 3D video. In this regard, the compressed video data may correspond to a plurality of view sequences, such as left and right views. In step 304, the compressed video data in the received transport streams may be processed. For example, the video decoder 244 may decode the compressed video data in the received video streams to extract, for example, the corresponding left view and right view sequences. In step 306, parameters and/or data utilized to control and/or adjust sharpness enhancement processing generated and/or extracted. For example, sharpness related 3D video information, user input, preconfigured and/or predetermined parameters, and/or embedded sharpness data may be generated, received, and/or extracted, substantially as described with regard to, for example, FIG. 2C.

In step 308, dynamic sharpness enhancement may be performed. For example, in instances where received 3D video content yields left and right view sequences, each view sequence may processed separately and/or dynamically to enhance image sharpness for corresponding output frames or fields, based on, for example, sharpness related 3D video data which is extracted, received and/or generated via the video processing system 240. In step 310, corresponding 3D output stream, comprising views with enhanced sharpness, may be generated, via the video processor 250. The generated output stream may be further processed, via the display processing module 252, to ensure that the generated output stream is suitable for playback via the display 260. In this regard, the display processing module 252 may perform motion compensation and/or frame upconversion, utilizing frame interpolation, for example.

Various embodiments of the invention may comprise a method and system for sharpness processing for 3D video. The video processing system 240 may extract, via the video decoder 244, a plurality of view sequences from compressed three-dimension (3D) input video streams, and may enhance, via the video processor 250, sharpness of one or more of the plurality of extracted view sequences separately and/or dynamically on each view sequence based on, for example, sharpness related information. The sharpness related information may enable classifying images in the 3D input video stream into different regions, to enable variably applying sharpness enhancement with the extracted view sequences. The plurality of extracted view sequences may comprise stereoscopic left view and right view sequences of reference fields or frames. The sharpness related information may be derived, for example via the video decoder 244, the video processor 250 and/or the host processor 242, from video data corresponding to the view sequences, user input, control data embedded into the received 3D input stream, and/or preconfigured and/or predetermined sharpness parameters. The sharpness related information derived from the video data corresponding to the view sequences may comprise, for example, depth related data and/or point-of-focus related data. Accordingly, sharpness enhancement processing may be performed, via the video processor 250, variably on background and foreground regions, and/or on in-focus or out-of-focus regions. In this regard, sharpness in foreground regions and/or in-focus regions may be enhanced more than background regions and/or out-of-focus regions. A 3D output video stream for playback via the display 260 may be generated, via the video processor 250, from the plurality of view sequences based on the sharpness enhancement processing. The generated 3D output video stream may be processed, via the display processing module 252, to ensure that it may be suitable for playback via the display 260, by performing, for example, motion compensation and/or frame upconversion, which may be performed, for example, utilizing frame interpolation.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for sharpness processing for 3D video.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
performing by one or more processors and/or circuits in a video processing system:
extracting a plurality of view sequences from a compressed three-dimension (3D) input video stream;
determining video information that classifies different regions of one or more images in said plurality of extracted view sequences; and
modifying sharpness of one or more of said extracted plurality of view sequences based on said video information.

2. The method according to claim 1, wherein said plurality of extracted view sequences comprises stereoscopic left view and right view sequences of reference fields or frames.

3. The method according to claim 1, wherein said video information comprises depth related data and/or point-of-focus related data.

4. The method according to claim 3, comprising performing said sharpness modification based on determination of whether an image region corresponds to in-focus or out-of-focus region.

5. The method according to claim 3, comprising classifying said image regions into foreground or background regions based on said depth related data.

6. The method according to claim 5, comprising performing said sharpness modification based on said determination of foreground or background regions.

7. The method according to claim 1, comprising generating a 3D output video stream for playback via a 3D display device based on said plurality of extracted view sequences comprising said modified sharpness.

8. The method according to claim 7, comprising adjusting sharpness data of said generated 3D output video stream based on said sharpness modification and/or said derived video data.

9. The method according to claim 7, comprising performing frame upconversion operations on said generated 3D output video stream utilizing frame or field interpolation.

10. The method according to claim 7, comprising locally performing graphics processing corresponding to said generated 3D output video stream.

11. A system for video processing, the system comprising:
one or more circuits and/or processors that are operable to extract a plurality of view sequences from a compressed three-dimension (3D) input video stream;
said one or more circuits and/or processors are operable to determine video information that classifies different regions of one or more images in said plurality of extracted view sequences; and
said one or more circuits and/or processors are operable to modify sharpness of one or more of said extracted plurality of view sequences based on said video information.

12. The system according to claim 11, wherein said plurality of extracted view sequences comprises stereoscopic left view and right view sequences of reference fields or frames.

13. The system according to claim 11, wherein said video information comprises depth related data and/or point-of-focus related data.

14. The system according to claim 13, wherein said one or more circuits and/or processors are operable to perform said sharpness modification based on determination of whether an image region corresponds to in-focus or out-of-focus region.

15. The system according to claim 13, wherein said one or more circuits and/or processors are operable to classify said image regions into foreground or background regions based on said depth related data.

16. The system according to claim 15, wherein said one or more circuits and/or processors are operable to perform said sharpness modification based on said determination of foreground or background regions.

17. The system according to claim 11, wherein said one or more circuits and/or processors are operable to generate a 3D output video stream for playback via a 3D display device based on said plurality of extracted view sequences comprising said modified sharpness.

18. The system according to claim 17, wherein said one or more circuits and/or processors are operable to adjust sharpness data of said generated 3D output video stream based on said sharpness modification and/or said derived video data.

19. The system according to claim 17, wherein said one or more circuits and/or processors are operable to perform frame upconversion operations on said generated 3D output video stream utilizing frame or field interpolation.

20. The system according to claim 17, wherein said one or more circuits and/or processors are operable to locally perform graphics processing corresponding to said generated 3D output video stream.
